(19) United States
(12) Patent Application Publication
(10) Pub. No.: US 2011/0036419 A1
(43) Pub. Date: Feb. 17, 2011

(54) VALVE FASTENING MEANS

(75) Inventor: Bertil Lundgren, Bjartra (SE)

Correspondence Address: YOUNG & THOMPSON, 209 Madison Street, Suite 500, Alexandria, VA, 22314, US

(73) Assignee: NORDHYDRAULIC AB, Kramfors (SE)

(21) Appl. No.: 12/989,791

(22) PCT Filed: Jun. 22, 2009
(86) PCT No.: PCT/SE09/50782

§ 371 Date: Oct. 27, 2010

(30) Foreign Application Priority Data
Jul. 7, 2008 (SE) 0801630-5

(51) Int. Cl. F16K 51/00

(52) U.S. Cl. 137/343

(57) ABSTRACT

A valve fastening element (1) for attaching a hydraulic valve (2) to a tractor (13). The valve fastening element (1) includes a tractor part (1a) adapted to be attached on the tractor and a valve part (1b adapted for direct assembly of the valve (2), wherein the valve (2) includes at least two screw holes (10,11,12), each adapted to receive a screw (3,4,5). The valve part (1b) of the valve fastening element (1) includes at least two slits (6,7,8), of which at least a first slit (6,8) includes an opening (6a,8a) adapted to let the head of the screw pass, and all slits include a groove (6b,7,8b,8c) that is sufficiently narrow to prevent the head of the screw (3,4,5) from passing but sufficiently wide to allow the thread of the screw (3,4,5) to pass.

### TECHNICAL FIELD OF THE INVENTION

The present invention relates to valve fastening means and in particular to a valve fastening means for attaching a hydraulic valve to a tractor with a front end loader.

### BACKGROUND OF THE INVENTION

Tractors with front end loaders and any associated tools that are operated hydraulically usually include a valve arranged at the attachment point of the front end loader on the tractor or on a foundation on the tractor. This valve connects the hydraulics of the tractor with the hydraulics of the front end loader.

Conventional valves include a number of screw holes, which enables attachment to an attachment plate that is mounted on a custom made fastening means on the tractor. One problem is that the valve is relatively heavy and that it is coupled to relatively stiff hydraulic hoses, which contribute to make it difficult to handle and difficult to mount.

### SUMMARY OF THE INVENTION

In view of the foregoing one object with the present invention is to provide a valve fastening means that simplifies engaging and disengaging of a valve on a tractor with a front end loader. Another object is to provide a valve fastening means that is cheaper than conventional ones.

A common idea of the invention is that it should be possible in a first step to attach the valve fastening means, in a second step to adjust the position of it, and in a third step to lock it in place, and that one person readily can perform all the steps without any help from another person.

This may be accomplished with the valve fastening means according to the invention as defined in the dependent claims.

According to a first aspect of the invention the invention relates to a valve fastening means for attaching a hydraulic valve to a tractor. The valve fastening means comprises a tractor part adapted to be attached to a tractor and a valve part adapted for direct assembly of the valve, wherein the valve comprises at least two screw holes, each adapted to receive a screw. The valve part of the valve fastening means comprises at least two slits, of which at least a first slit comprises an opening adapted to let the head of the screw pass, and all the slits each comprises a groove that is sufficiently narrow to prevent the head of the screw pass from passing but sufficiently wide to allow the thread of the screw to pass.

In a preferred embodiment the valve fastening means comprises three slits, of which at least two slits each comprises an opening adapted to let the head of the screw pass, and of which all slits each comprises a groove that is sufficiently narrow to prevent the head of the screw pass from passing but sufficiently wide to allow the thread of the screw to pass.

In another preferred embodiment the grooves are parallel to each other so that the valve, when mounted in the valve fastening means without having the screws fully tightened, can be moved along the grooves in such way that the screws are moved in their respective groove.

Preferably one of the slits does not have any opening for letting the head of the screw pass and optionally this slit is displaced from the slits with an opening and from the position of the screw holes on the valve, whereby the screw that is extending through the slit that does not have any opening has to be screw out in order to enable movement of the valve to a position where the screws, which are extending through the slits that have an opening, are positioned just in front of these openings.

In yet another preferred embodiment the valve part comprises three slits. A first slit and a second slit are arranged one after the other in a common horizontal line, and a third slit is arranged in parallel, but vertically displaced in relation to the other two slits. Each of the first slit and the third slit comprises an opening adapted to let the head of the screw pass and a first groove that is sufficiently narrow to prevent the head of the screw from passing but sufficiently wide to allow the thread of the screw to pass and that extends in parallel and in the same direction in relation to their respective opening, and wherein the second slit comprises a groove but not an opening.

Preferably the third slit comprises a second groove that extends in parallel but in opposite direction from the opening of the slit in relation to the first slit.

In yet another preferred embodiment the slits are arranged relative each other in such way that the valve fastening means can be attached to the tractor in two different orientations, of which one is upside-down in relation to the other, whereby the valve can be arranged properly oriented on the valve fastening means irrespective of the orientation of the valve fastening means on the tractor.

Preferably the tractor part and the valve part are arranged at an angle to each other.

One advantage of the present invention over conventional valve fastening means is that no attachment plate is required. Previously, as described above, the valve has been attached to an attachment plate and thereafter the attachment plate has been attached to an holder intended for this purpose. Thanks to the invention the valve fastening means can be attached to the tractor, and the valve can in a simple and reliable way be attached directly to the valve fastening means.

Embodiments of the invention are defined in the dependent claims. Other objects, advantages and novel features of the invention will become apparent from the following detailed description of the invention when considered in conjunction with the accompanying drawings and claims.

### BRIEF DESCRIPTION OF THE DRAWINGS

Preferred embodiments of the invention will now be described with reference to the accompanying drawings, wherein

FIG. 1 schematically illustrates a valve fastening means according to the invention, to which a valve is attached,

FIGS. 1-6 schematically illustrate the process from the situation when a valve is threaded on to the valve fastening means until the situation when the valve is attached to the valve fastening means,

FIGS. 7-10 schematically illustrate a valve that is attached to a valve fastening means according to a second embodiment of the invention,

FIGS. 11-14 schematically illustrate a valve that is attached to a valve fastening means according to the second embodiment, wherein the valve fastening means is turned upside-down with regards to FIGS. 7-10, and

FIG. 15 schematically illustrates a perspective view of a tractor with a front end loader and an attached valve.

### DETAILED DESCRIPTION OF EMBODIMENTS

FIG. 15 schematically illustrates a perspective view of a tractor 13 with a front end loader 14 and an attached valve 2. The front end loader 14 and the tool 15 belonging to it is operated using hydraulics of the tractor via a valve 2 that is arranged at the attachment point of the front end loader 14 on the tractor 13 or on a foundation on the tractor 13. The valve connects the hydraulics of the tractor with the hydraulics of the front end loader. The invention relates to improvements associated with the valve fastening means which is used to attach the valve to the tractor.

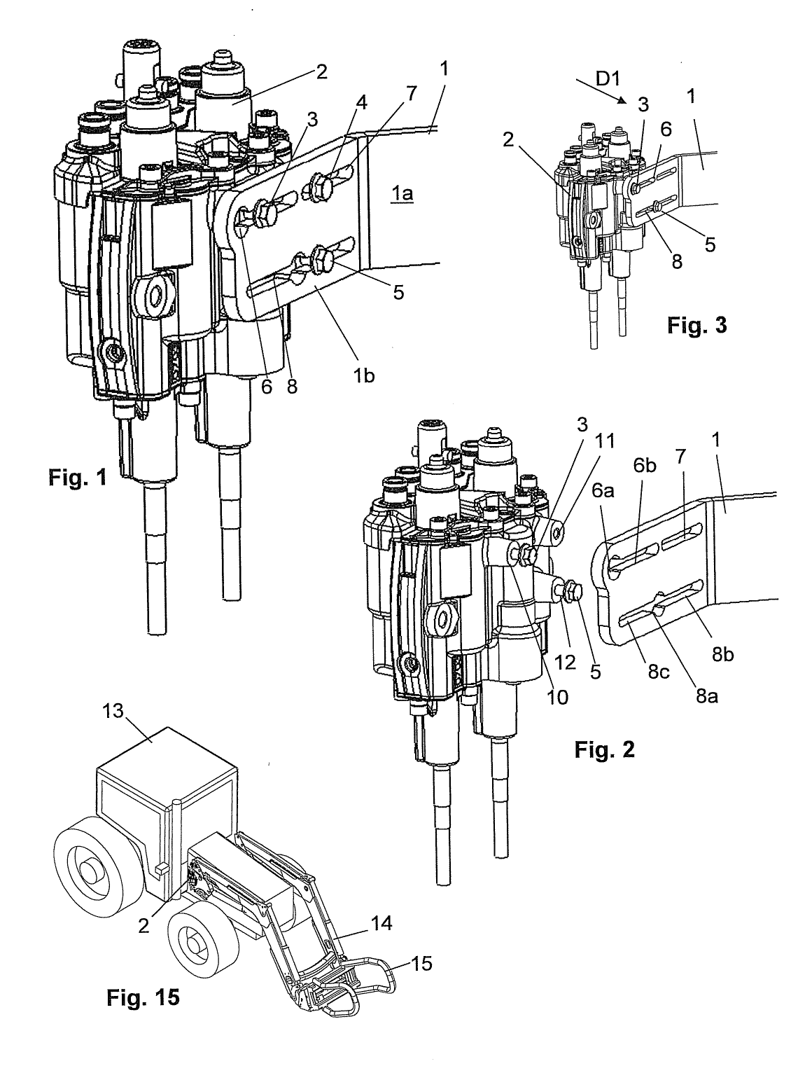

As shown in FIG. 1 the valve fastening means comprises two main parts that are put at an angle to each other. A first part, which hereinafter will be referred to as tractor part 1a, is intended to be attached in a suitable manner and on a suitable place on the tractor. A second part, which hereinafter will be referred to as valve part 1b, is adapted for attachment of a valve 2. As shown in FIG. 1, three slits 6,7 and 8 are arranged in the valve part lb and three screws 3,4 and 5 extend into the valve.

FIGS. 2-6 schematically illustrate one embodiment of a method for attaching a valve to a valve fastening means according to the present invention.

As shown in FIG. 2, the valve is provided with three screw holes 10,11 and 12, which are adapted to receive the screws 3,4 and 5. The screw holes 10 and 11 are arranged on the same height or horizontal line and the screw holes 11 and 12 are arranged on the same vertical line, whereby the three screw holes form a right-angled triangle. In FIG. 2, the valve is shown in the situation when it is going to be attached to the valve fastening means. In this situation, two screws 3 and 5 has been screw in a few turns in two of the screw holes 10 and 12, respectively. However, the screw hole 11 is empty at this stage. The slits 6 and 8 are each provided with an opening 6a and 8a, respectively. The screw heads 3 and 5 can be inserted in the openings 6a and 8a, respectively, in order to attach the valve before it is adjusted laterally and finally is fixed.

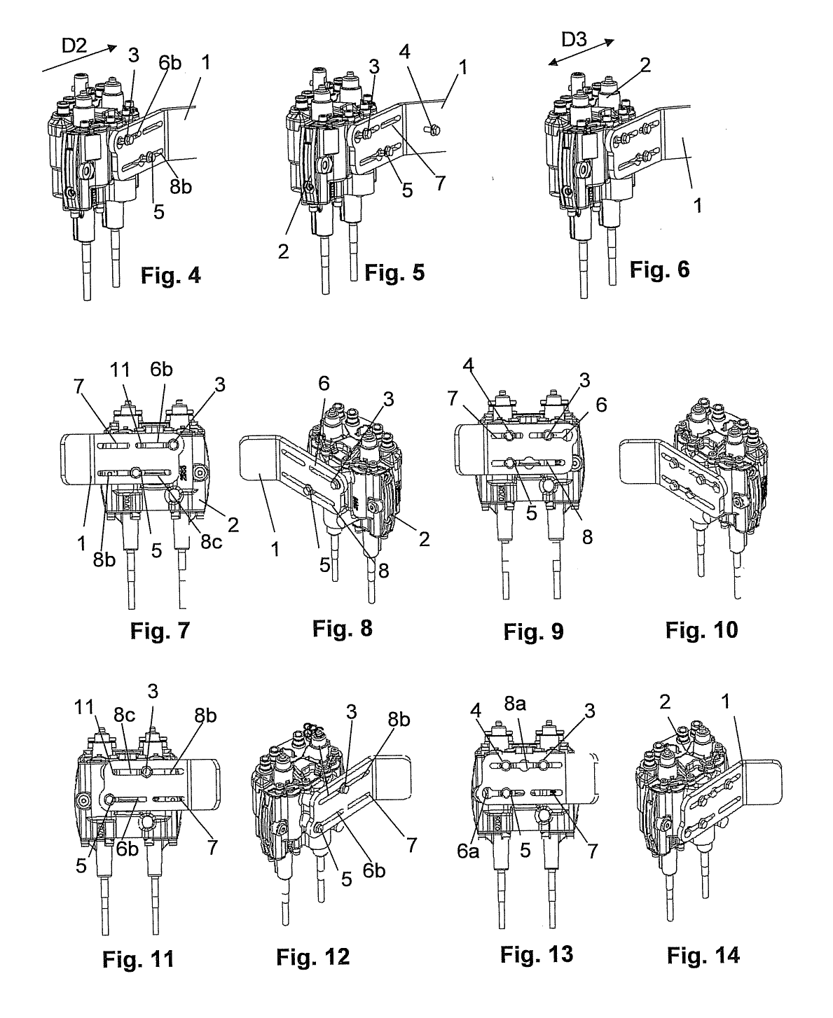

FIG. 3 schematically illustrates the valve on the valve fastening means after the screw heads 3 and 5 have been moved in the direction D1 through the openings 6a and 8a in the slits 6 and 8, respectively. Thereafter, as shown in FIG. 4, the valve can be moved in direction D2, whereby the screws are displaced from the openings 6a and 8a in the longitudinal grooves 6b and 8b, respectively.

When the valve has been moved to a desired position the valve can be fixed. This is accomplished by, as shown in FIG. 5, inserting the remaining screw 4 into the hitherto empty slit 7. This slit is in the present embodiment not provided with any opening and consists of only a groove, which groove is corresponding to the grooves 6b and 8b in the slits 6 and 8, respectively. The reason to why there is no opening is that the screw 4 is intended to be screw in into the slit 7 after the valve has been attached the valve fastening means 1. Hence there is no need for any opening. Moreover, the lack of any opening in the slit 7 efficiently locks the valve in place, since the screw has to be removed in order to remove the valve 2. The slit is with advantage be displaced relatively the slits 6 and 8, in such way that the screws 3 and 5 has to be moved into their respective groove 6b and 8b in order to make the hole 11 available through the slit 7 and to make it possible to screw in the screw 4 into the hole 11 (see FIG. 2).

With advantage the screws 3 and 5, which only have been screw in a few turns, are screw home at the same time as the last screw 4 is tightened Thereby the valve position is fixed. Before the screws 3,4 and 5 are screw home it is, as indicated in FIG. 6, possible to laterally adjust the valve 1 in the direction D3.

FIG. 7-14 schematically illustrate a second embodiment of the valve fastening means 1 that is mirrored with regards to the valve fastening means shown in FIGS. 1-6. Also the hole pattern for the screw holes 10-12 on the valve is mirrored with regards to the valve shown in FIGS. 1-6. However, the same reference numbers are used in all figures independently of whether the structures are mirrored or not.

In FIGS. 7 and 8, the valve fastening means 1 and the valve are in the relative positions that correspond to the relative positions in FIG. 3, i.e. with the screws 3 and 5 in front of the openings 6a and 8a. From FIG. 7 it is appreciated that no screw hole 11 is available through the slit 7 in this position. Instead the right part of the screw hole is visible through the groove 6b. Thus the valve has to be moved to the left with regards to the valve fastening means, i.e. towards the position that is shown in FIGS. 9 and 10 before the screw can be inserted into the last screw hole 11.

One advantage with the valve fastening means according to the invention is that it is turnable, i.e. the valve part lb can be attached in any orientation on the tractor with maintained functionality.

FIGS. 11-14 show the second embodiment of the valve fastening means 1 arranged upside-down with regards to the arrangement in FIGS. 7-10. Thus the slit 8 is arranged in an upper part and the slits 6 and 7 are arranged below the slit 8. The screw 3, which is arranged in the screw hole 10 on the valve, is in this embodiment inserted through the opening 8a, while the screw 5, which is arranged in the screw hole 12, is inserted through the opening 6a. In accordance with the function of the valve fastening means when it is arranged in the opposite orientation (upside-down), as in FIGS. 7-10, the third screw hole 11 is covered sufficiently much not to be available as long as the screws remains in the openings 6a and 8a. However, in FIG. 11 a portion of the screw hole 11 can be observed through the left part of the groove 8c.

In the situation that is shown in FIGS. 13 and 14 the valve 2 has been displaced to the right with regards to the valve fastening means 1 and the third screw 4 has been screw in through a second groove 8c in the slit 8. Thus the slit 7 is not used at all when the valve fastening means 1 has this orientation. The function of the slit 7 is than provided by the left groove 8c in the slit 8.

While the invention has been described in connection with what is presently considered to be the most practical and preferred embodiments, it is to be understood that the invention is not to be limited to the disclosed embodiments, on the contrary, it is intended to cover various modifications and equivalent arrangements within the appended claims.

1. Valve fastening means (1) for attachment of a hydraulic valve (2) on a tractor comprising a tractor part (1a) adapted to be attached on a tractor and a valve part (1b) adapted for direct assembly of the valve (2), wherein the valve (2) comprises at least two screw holes (10,11,12), each adapted to receive a screw (3,4,5),
wherein the valve part (1b) of the valve fastening means comprises at least two slits (6,7,8), of which at least a first slit (6,8) comprises a opening (6a,8a) adapted to let the head of the screw (3,5) pass, and of which all slits each comprises a groove (6b,7,8b,8c) that is sufficiently narrow to prevent the head of the screw (3,4,5) from passing but sufficiently wide to allow the thread of the screw (3,4,5) pass, and wherein the grooves (6b,7,8b,8c) are parallel to each other so that the valve (2), when attached to the valve fastening means without having the screws fully tightened, can be moved along the grooves (6b,7,8b,8c) in such way that the screws (3,4,5) are moved in their respective groove (6b,7,8b,8c), characterised in that one of the slits (7,8c) does not have any opening for letting the head of the screw (4) pass, which slit (7,8c) is displaced from the slits (6,8) with an opening (6a,8a) and from the position of the screw holes (10,11,12) on the valve (2), whereby the screw (4) without opening, which extends through the slit (7,8c), has to be screw out in order to enable movement of the valve (2) to a position where the screws with opening (6a,8a) that extend through the slits (6,8) are positioned just in front of these openings (6a,8a).

2. Valve fastening means (1) according to claim 1, wherein the valve fastening means (1) comprises three slits (6,7,8), of which at least two slits (6,8) each comprises an opening (6a,8a) adapted to let the head of the screw (3,5) pass.

3. Valve fastening means (1) according to claim 2, wherein a first slit (6) and a second slit (7) are arranged one after the other in a common horizontal line, and a third slit (8) is arranged in parallel, but vertically displaced, in relation to the other two slits (6,7), and wherein the first slit (6) and the third slit (8) each comprises an opening (6b,8b) adapted to let the head of the screw (3,5) pass and a first groove (6b,8b) that is sufficiently narrow to prevent the head of the screw (3,5) from passing but sufficiently wide to allow the thread of the screw (3,5) to pass and that extends in parallel and in the same direction in relation to their respective opening (6a,8a), and wherein the second slit (7) comprises a groove but not an opening.

4. Valve fastening means (1) according to claim 3, wherein the third slit (8) comprises a second groove (8c) that extends in parallel but in opposite direction from the opening (8a) of the slit (8) in relation to the first slit (8b).

5. Valve fastening means (1) according to claim 1, wherein said slits (6,7,8) are arranged relative each other in such way that the valve fastening means (1) can be attached to the tractor in two different orientations, of which one is upside-down in relation to the other, whereby the valve (2) properly oriented can be arranged on the valve fastening means (1) irrespective of the orientation of the valve fastening means (1) on the tractor.

6. Valve fastening means (1) according to claim 1, wherein the tractor part (1a) and the valve part (1b) are arranged at an angle to each other.

7. Valve fastening means (1) according to claim 2,
wherein said slits (6,7,8) are arranged relative each other in such way that the valve fastening means (1) can be attached to the tractor in two different orientations, of which one is upside-down in relation to the other, whereby the valve (2) properly oriented can be arranged on the valve fastening means (1) irrespective of the orientation of the valve fastening means (1) on the tractor.

8. Valve fastening means (1) according to claim 3,
wherein said slits (6,7,8) are arranged relative each other in such way that the valve fastening means (1) can be attached to the tractor in two different orientations, of which one is upside-down in relation to the other, whereby the valve (2) properly oriented can be arranged on the valve fastening means (1) irrespective of the orientation of the valve fastening means (1) on the tractor.

9. Valve fastening means (1) according to claim 4,
wherein said slits (6,7,8) are arranged relative each other in such way that the valve fastening means (1) can be attached to the tractor in two different orientations, of which one is upside-down in relation to the other, whereby the valve (2) properly oriented can be arranged on the valve fastening means (1) irrespective of the orientation of the valve fastening means (1) on the tractor.

10. Valve fastening means (1) according to claim 2,
wherein the tractor part (1a) and the valve part (1b) are arranged at an angle to each other.

11. Valve fastening means (1) according to claim 3,
wherein the tractor part (1a) and the valve part (1b) are arranged at an angle to each other.

12. Valve fastening means (1) according to claim 4,
wherein the tractor part (1a) and the valve part (1b) are arranged at an angle to each other.

13. Valve fastening means (1) according to claim 5, wherein the tractor part (1a) and the valve part (1b) are arranged at an angle to each other.
